(19) United States
(12) Patent Application Publication
(10) Pub. No.: US 2025/0071010 A1
(43) Pub. Date: Feb. 27, 2025

(54) MONITORING SYSTEM, MONITORING METHOD, AND RECORDING MEDIUM STORING MONITORING PROGRAM

(71) Applicant: SHARP KABUSHIKI KAISHA, Sakai City (JP)

(72) Inventors: NORIYUKI KOYAMA, Sakai City (JP); TAKAHIRO ICHITSUKA, Sakai City (JP)

(21) Appl. No.: 18/788,196

(22) Filed: Jul. 30, 2024

(30) Foreign Application Priority Data
Aug. 25, 2023 (JP) 2023-136904

(51) Int. Cl. H04L 41/06

(52) U.S. Cl. CPC H04L 41/06

(57) ABSTRACT

A monitoring system includes a device to be monitored and a monitoring device communicably connected to the device to be monitored. When an abnormality is detected in the device to be monitored, the device to be monitored blocks a communication path established with the monitoring device, and when the abnormality is detected in the device to be monitored, the device to be monitored displays abnormality information regarding the abnormality on an operation display of the device to be monitored. The monitoring device notifies an administrator terminal of predetermined notification information when a state in which the communication path established with the device to be monitored is blocked continues for a predetermined time period.

### INCORPORATION BY REFERENCE

This application is based upon and claims the benefit of priority from the corresponding Japanese Patent Application No. 2023-136904 filed on Aug. 25, 2023, the entire contents of which are incorporated herein by reference.

### BACKGROUND

The disclosure relates to a monitoring system, a monitoring method, and a recording medium storing a monitoring program.

In the related art, a system is known that notifies an administrator when an abnormality occurs in a device to be monitored. For example, in the system, a server determines whether or not a communication path with the device to be monitored (client terminal) is continuously connected, and when it is determined that the communication path is not connected for a predetermined time period or longer, the server notifies the administrator of an abnormality of the device to be monitored.

However, in the related art, since the server determines the abnormality of the device to be monitored based on the presence or absence of the connection of the communication path with the device to be monitored, for example, even when an abnormality occurs in the device to be monitored, if the communication path is in a normal state, the server cannot detect the abnormality of the device to be monitored. For example, when a hard disk drive (HDD) fails or a usage of the HDD exceeds a specified value in the device to be monitored, if the communication path of the device to be monitored is in the normal state, the server cannot detect the abnormality. In this manner, in the related art, when an abnormality occurs in the device to be monitored in a state in which the communication path of the device to be monitored is in the normal state, it is difficult to notify the administrator of the abnormality.

### SUMMARY

An object of the disclosure is to provide a monitoring system, a monitoring method, and a recording medium storing a monitoring program that, when an abnormality occurs in a device to be monitored in a state in which a communication path of the device to be monitored is in a normal state, are capable of notifying an administrator of the abnormality.

A monitoring system according to an aspect of the disclosure includes a device to be monitored, and a monitoring device communicably connected to the device to be monitored. The device to be monitored includes a communication processing unit that blocks a communication path established with the monitoring device when an abnormality is detected in the device to be monitored, and a display processing unit that displays abnormality information regarding the abnormality, on a display of the device to be monitored, when the abnormality is detected in the device to be monitored. The monitoring device includes a notification processing unit that notifies a user terminal of predetermined notification information when a state in which the communication path established with the device to be monitored is blocked continues for a predetermined time period.

A monitoring method according to another aspect of the disclosure is a monitoring method in a monitoring system including a device to be monitored, and a monitoring device communicably connected to the device to be monitored. In the monitoring method, one or a plurality of processors execute blocking a communication path with the monitoring device when an abnormality is detected in the device to be monitored, displaying, when the abnormality is detected in the device to be monitored, abnormality information regarding the abnormality, on a display of the device to be monitored, and notifying a user terminal of predetermined notification information when a state in which the communication path is blocked continues for a predetermined time period.

A recoding medium according to another aspect of the disclosure is a recording medium storing a monitoring program in a monitoring system including a device to be monitored, and a monitoring device communicably connected to the device to be monitored. The monitoring program is a program for causing one or a plurality of processors to execute blocking a communication path with the monitoring device when an abnormality is detected in the device to be monitored, displaying, when the abnormality is detected in the device to be monitored, abnormality information regarding the abnormality, on a display of the device to be monitored, and notifying a user terminal of predetermined notification information when a state in which the communication path is blocked continues for a predetermined time period.

According to the disclosure, a monitoring system, an information processing method, an information processing program that, when an abnormality occurs in a device to be monitored in a state in which a communication path with the device to be monitored is in a normal state, are capable of notifying an administrator of the abnormality.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating an overall configuration of a monitoring system according to an embodiment of the disclosure.

FIG. 2 is a functional block diagram illustrating a configuration of the monitoring system according to the embodiment of the disclosure.

FIG. 3 is a diagram illustrating an example of notification information (mail) notified to an administrator terminal by a cloud server according to the embodiment of the disclosure.

FIG. 4 is a diagram illustrating an example of abnormality information (message) displayed on a device to be monitored according to the embodiment of the disclosure.

FIG. 5 is a diagram illustrating an example of the abnormality information (message) displayed on the device to be monitored according to the embodiment of the disclosure.

FIG. 6 is a flowchart illustrating an example of a procedure of monitoring processing executed by the monitoring system according to the embodiment of the disclosure.

FIG. 7 is a flowchart illustrating an example of a procedure of monitoring processing executed by the monitoring system according to the embodiment of the disclosure.

FIG. 8 is a diagram illustrating an overall configuration of the monitoring system according to another embodiment of the disclosure.

### DETAILED DESCRIPTION

Embodiments of the disclosure will be described below with reference to the drawings. Note that the following embodiments are specific examples of the disclosure, and do not limit the technical scope of the disclosure.

### Monitoring System 10

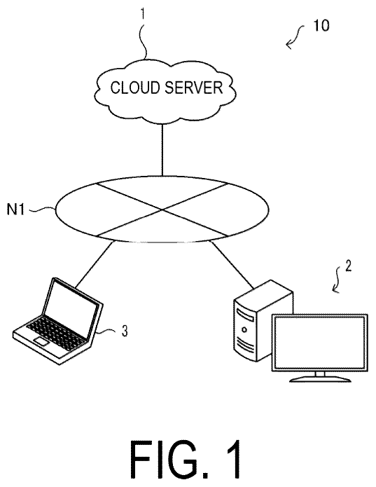

FIG. 1 is a diagram illustrating an overall configuration of a monitoring system 10 according to an embodiment of the disclosure. The monitoring system 10 includes a cloud server 1, a device to be monitored 2, and an administrator terminal 3.

The cloud server 1 is constituted by one or a plurality of servers (virtual servers), for example. The device to be monitored 2 is an information processing device such as a personal computer or a data server. The administrator terminal 3 is an operation terminal such as a personal computer or a smartphone. Although one of the cloud servers 1, one of the devices to be monitored 2, and one of the administrator terminals 3 are illustrated in FIG. 1, the monitoring system 10 may include two or more of the cloud servers 1, two or more of the devices to be monitored 2, and two or more of the administrator terminals 3. The cloud server 1 is an example of a monitoring device of the disclosure, the device to be monitored 2 is an example of a device to be monitored of the disclosure, and the administrator terminal 3 is an example of a user terminal of the disclosure.

The cloud server 1, the device to be monitored 2, and the administrator terminal 3 are connected to each other via a network N1. The network N1 is a communication network such as the Internet.

The monitoring system 10 is a system that monitors an abnormality of the device to be monitored 2, and notifies the administrator terminal 3 of abnormality information when an abnormality is detected. Specifically, the cloud server 1 establishes a secure communication path (for example, a WebSocket communication path) with the device to be monitored 2, and determines whether or not there is an abnormality in the device to be monitored 2 based on a state (an established state or a blocked state) of the communication path. When the communication path is blocked, the cloud server 1 determines that an abnormality has occurred in the device to be monitored 2 and notifies the administrator terminal 3 of predetermined notification information. Further, the device to be monitored 2 monitors a state of a component of the device to be monitored 2 (for example, a storage 22), and when it is determined that an abnormality occurs in the component, the device to be monitored 2 blocks the communication path with the cloud server 1 and causes a display of the device to be monitored 2 (an operation display 23) to display abnormality information regarding the content of the abnormality. When an administrator receives the notification information notified to the administrator terminal 3 from the cloud server 1, the administrator checks the abnormality information displayed on an operation display 23 of the device to be monitored 2 and takes a countermeasure action to resolve the abnormality.

In this manner, in the monitoring system 10 according to the disclosure, when the device to be monitored 2 detects an abnormality in the component thereof, the communication path established between the device to be monitored 2 and the cloud server 1 is intentionally blocked to cause the cloud server 1 to notify the administrator terminal 3 of the notification information, thereby causing the administrator to recognize the occurrence of the abnormality in the device to be monitored 2. Hereinafter, a specific configuration of the monitoring system 10 will be described.

### Cloud Server 1

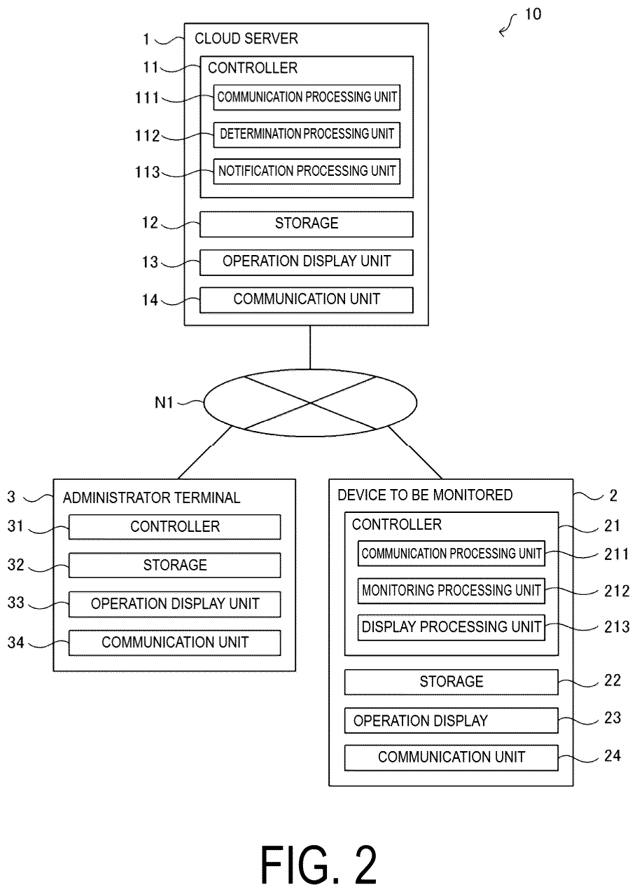

As illustrated in FIG. 2, the cloud server 1 includes a controller 11, a storage 12, an operation display 13, a communication unit 14, and the like. The cloud server 1 is constituted by one or a plurality of virtual servers. Note that the monitoring device of the disclosure is not limited to the cloud server and may be one or a plurality of physical servers.

The communication unit 14 is a communication interface for connecting the cloud server 1 to the network N1 in a wired or wireless manner and performing data communication with the device to be monitored 2 via the network N1 in accordance with a predetermined communication protocol. For example, the communication unit 14 is a communication interface for performing data communication in accordance with the WebSocket communication protocol. The communication unit 14 is connected to a communication unit 24 of the device to be monitored 2, and establishes a WebSocket communication path between the cloud server 1 and the device to be monitored 2. Note that the communication path established between the cloud server 1 and the device to be monitored 2 is not limited to the WebSocket communication path, and may be another communication path such as an HTTP communication path.

The operation display 13 is a user interface including a display such as a liquid crystal display or an organic EL display that displays various types of information, and an operation unit such as a mouse, a keyboard, or a touch panel that receives an operation.

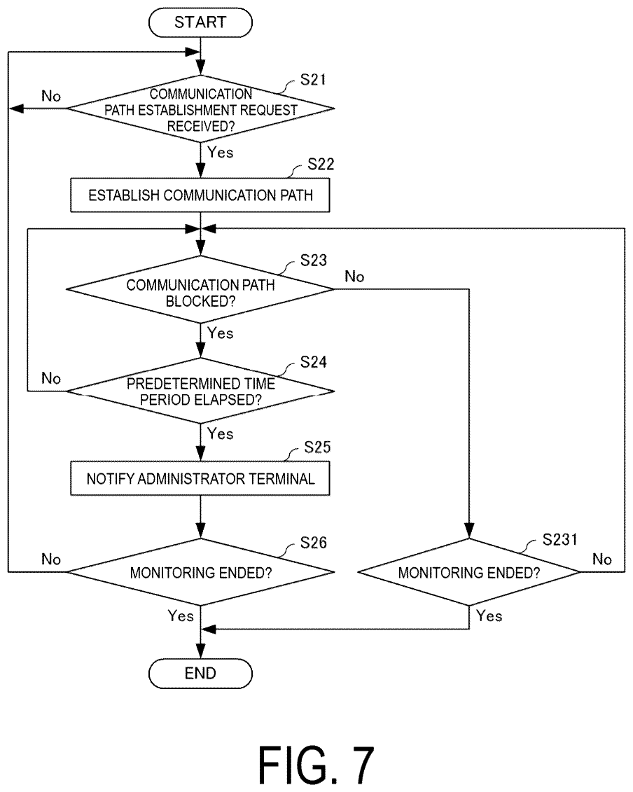

The storage 12 is a non-volatile storage such as a hard disk drive (HDD), a solid state drive (SSD), or a flash memory that stores various types of information. The storage 12 stores a control program such as a monitoring program for causing the controller 11 to execute monitoring processing (see FIG. 7) described below. For example, the control program is non-temporarily recorded in a computer-readable recording medium such as a CD or a DVD, read by a reading device (not illustrated) such as a CD drive or a DVD drive included in the cloud server 1, and stored in the storage 12. Note that the control program may be distributed from another server and stored in the storage 12.

The controller 11 includes control devices such as a CPU, a ROM, and a RAM. The CPU is a processor that executes various types of arithmetic processing. The ROM stores in advance control programs such as a BIOS and an OS for causing the CPU to execute various types of processing. The RAM stores various types of information and is used as a temporary storage memory (work area) for the various types of processing executed by the CPU. Then, the controller 11 controls the cloud server 1 by causing the CPU to execute various types of the control programs stored in advance in the ROM or the storage 12.

Specifically, the controller 11 includes various processors such as a communication processing unit 111, a determination processing unit 112, and a notification processing unit 113. Note that the controller 11 functions as the various processors by executing various types of processing in accordance with the control programs. Further, some or all of the processors included in the controller 11 may be constituted by an electronic circuit. Note that the control program may be a program for causing a plurality of processors to function as the various types of processors.

The communication processing unit 111 establishes a communication path (for example, a WebSocket communication path) with the device to be monitored 2. Specifically, the communication processing unit 111 acquires a communication path establishment request (described later) from the device to be monitored 2, and establishes a communication path when a token corresponding to the establishment request matches an issued token. A known technique can be employed as a method for establishing the communication path.

Further, when the communication path is established with the device to be monitored 2, the communication processing unit 111 registers device information related to the device to be monitored 2 in the storage 12. The device information includes, for example, information such a product name, a name, an IP address, a service (search) IP address, a MAC address, a S/N, an installation location, and a connection status. When the communication path is established and the device information is registered, the cloud server 1 starts monitoring a communication state (established state of the communication path) with the device to be monitored 2.

The determination processing unit 112 determines (monitors) a state of the communication path established with the device to be monitored 2. Specifically, the determination processing unit 112 determines whether or not the communication path is in an established state or in a blocked state. For example, the determination processing unit 112 determines the state of the communication path at a predetermined cycle (for example, every 60 seconds).

Further, when the communication path transitions from the established state to the blocked state, the determination processing unit 112 determines whether or not the blocked state has continued for a predetermined time period. Specifically, the determination processing unit 112 determines whether or not an elapsed time (an elapsed time in the blocked state) from a timing at which the communication path has transitioned from the established state to the blocked state has reached the predetermined time period (for example, 60 minutes).

When the communication path established with the device to be monitored 2 is blocked, the notification processing unit 113 notifies the administrator terminal 3 of predetermined notification information. Specifically, the notification processing unit 113 notifies the administrator terminal 3 of the predetermined notification information when the state in which the communication path established with the device to be monitored 2 is blocked continues for the predetermined time period (for example, 60 minutes). That is, the notification processing unit 113 notifies the administrator terminal 3 of the notification information when the determination processing unit 112 determines that the elapsed time (the elapsed time in the blocked state) from the timing at which the communication path has transitioned from the established state to the blocked state has reached the predetermined time period (for example, 60 minutes).

For example, when the power supply is cut off in the device to be monitored 2, or when the communication environment is deteriorated and the communication path is forcibly blocked, the notification processing unit 113 notifies the administrator terminal 3 of the notification information at the timing at which the state in which the communication path is blocked has continued for the predetermined time period.

Further, for example, when an abnormality occurs in a component (for example, the storage 22) of the device to be monitored 2 and the device to be monitored 2 itself blocks the communication path, the notification processing unit 113 notifies the administrator terminal 3 of the notification information at a timing at which the state in which the communication path is blocked has continued for the predetermined time period.

The notification information includes information indicating that the communication path with the device to be monitored 2 has been blocked and that there is a possibility that an abnormality has occurred in the device to be monitored 2. Further, the notification information includes the device information (the product name, the name, the IP address, the service (search) IP address, the MAC address, the S/N, the installation location, the connection status, and the like) related to the device to be monitored 2 that is a communication destination.

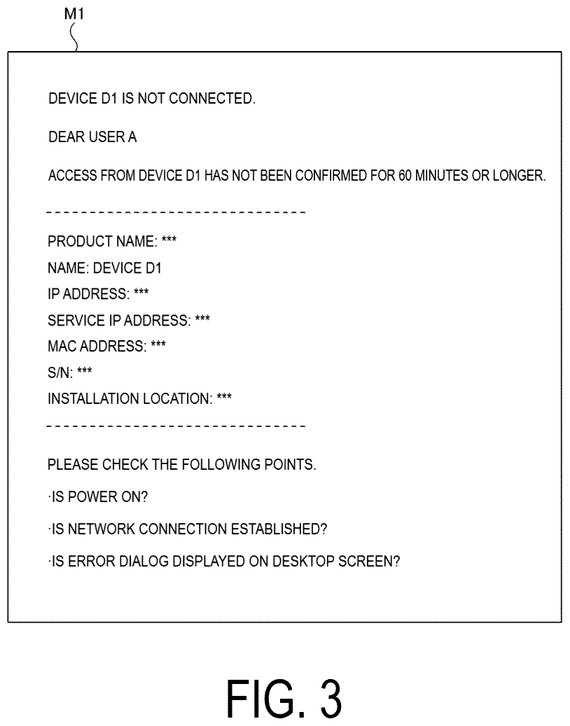

FIG. 3 illustrates a mail M1 as an example of the notification information. As illustrated in FIG. 3, the mail M1 includes a message indicating that the communication path with the device to be monitored 2 (here “device D1”) is blocked (“device D1 is not connected”), a message indicating the device information (the product name, the name, the IP address, the service IP address, the MAC address, the S/N, and the installation location), a message indicating that there is a possibility that an abnormality has occurred in the device to be monitored (“Is the power on?”, “Is the network connection established?”, and “Is an error dialog displayed on the desktop screen?), and the like. The notification processing unit 113 transmits the mail M1 corresponding to the notification information to the administrator terminal 3. Note that, in the storage 22, identification information of the device to be monitored 2 and identification information (including a mail address) of the administrator terminal 3 of the administrator, who manages the device to be monitored 2, are registered in advance.

When the administrator checks the mail M1 displayed on the administrator terminal 3, the administrator recognizes that some kind of abnormality has occurred in the device to be monitored 2. Accordingly, the administrator goes to, for example, the installation location of the device to be monitored 2, checks the content of the abnormality (described later) displayed on the device to be monitored 2, and deals with the abnormality in accordance with the content of the abnormality.

### Device to be Monitored 2

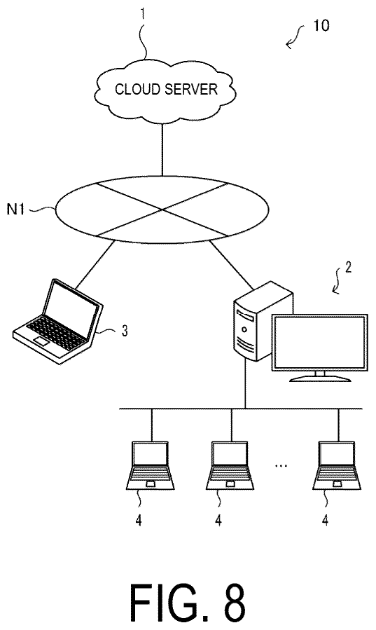

As illustrated in FIG. 2, the device to be monitored 2 includes a controller 21, a storage 22, an operation display 23, the communication unit 24, and the like. The device to be monitored 2 is an information processing device such as a personal computer or a data server. For example, the device to be monitored 2 may have a monitoring function of monitoring operations of one or a plurality of user terminals (details will be described later with reference to FIG. 8).

The communication unit 24 is a communication interface for connecting the device to be monitored 2 to the network N1 in a wired or wireless manner and performing data communication with the cloud server 1 via the network N1 in accordance with a predetermined communication protocol. For example, the communication unit 24 is a communication interface for performing data communication in accordance with the WebSocket communication protocol. The communication unit 24 is connected to the communication unit 14 of the cloud server 1 and establishes, for example, a WebSocket communication path between the cloud server 1 and the device to be monitored 2.

The operation display 23 is a user interface including a display such as a liquid crystal display or an organic EL display that displays various types of information and an operation unit such as a mouse, a keyboard, or a touch panel that receives an operation.

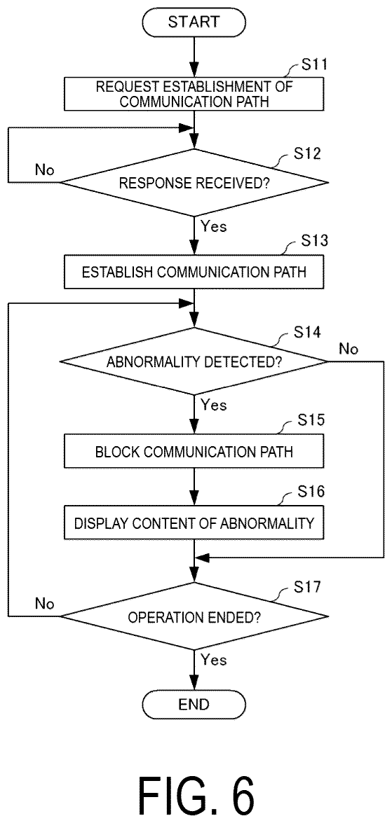

The storage 22 is a non-volatile storage such as an HDD, an SSD, or a flash memory that stores various types of information. The storage 22 stores a control program such as a monitoring program for causing the controller 21 to execute monitoring processing (see FIG. 6) described below. For example, the control program is non-temporarily recorded in a computer-readable recording medium such as a CD or a DVD, read by a reading device (not illustrated) such as a CD drive or a DVD drive included in the device to be monitored 2, and stored in the storage 22. Note that the control program may be distributed from another server and stored in the storage 22.

Further, log data acquired from a plurality of user terminals monitored by the device to be monitored 2 is stored in the storage 22. The log data includes, for example, access history information of websites accessed by the user terminals.

The controller 21 includes control devices such as a CPU, a ROM, and a RAM. The CPU is a processor that executes various types of arithmetic processing. The ROM stores in advance control programs such as a BIOS and an OS for causing the CPU to execute various types of processing. The RAM stores various types of information and is used as a temporary storage memory (work area) for the various types of processing executed by the CPU. The controller 21 controls the device to be monitored 2 by causing the CPU to execute various types of the control programs stored in advance in the ROM or the storage 22.

Specifically, the controller 21 includes various processors such as a communication processing unit 211, a monitoring processing unit 212, and a display processing unit 213. Note that the controller 21 functions as the various processors by executing the various types of processing in accordance with the control programs. Further, some or all of the processors included in the controller 21 may be constituted by an electronic circuit. Note that the control program may be a program for causing a plurality of processors to function as the various types of processors.

The communication processing unit 211 establishes a communication path (for example, a WebSocket communication path) with the cloud server 1. Specifically, the communication processing unit 211 transmits a communication path establishment request to the cloud server 1, and establishes a communication path upon receiving a response from the cloud server 1. A known technique can be employed as a method for establishing the communication path.

When the communication path is established and the device information of the device to be monitored 2 is registered in the cloud server 1, monitoring processing of the communication path by the cloud server 1 is started.

The monitoring processing unit 212 monitors a component of the device to be monitored 2. Specifically, the monitoring processing unit 212 monitors a state (normal or failure, a storage capacity (usage), or the like) of the storage 22. The storage 22 is an example of the component. Note that the component may be the CPU (controller 21), the operation display 23, the communication unit 24, or the like. For example, the monitoring processing unit 212 determines whether the storage 22 is in a normal state or has failed. Further, for example, the monitoring processing unit 212 determines whether or not usage of the storage capacity has exceeded a specified value (threshold value).

When the communication path is established with the cloud server 1, the communication processing unit 211 maintains or blocks establishment information of the communication path based on a monitoring result by the monitoring processing unit 212. For example, when it is determined that the storage 22 has failed, or when it is determined that the usage of the storage capacity has exceeded the specified value, the monitoring processing unit 212 determines that an abnormality has occurred in the storage 22. When the monitoring processing unit 212 determines that an abnormality has occurred in the storage 22, the communication processing unit 211 blocks the communication path established with the cloud server 1.

When the communication processing unit 211 of the device to be monitored 2 blocks the communication path established with the cloud server 1, the notification processing unit 113 of the cloud server 1 notifies the administrator terminal 3 of the notification information (mail M1 illustrated in FIG. 3) when the state in which the communication path is blocked continues for the predetermined time period (for example, 60 minutes).

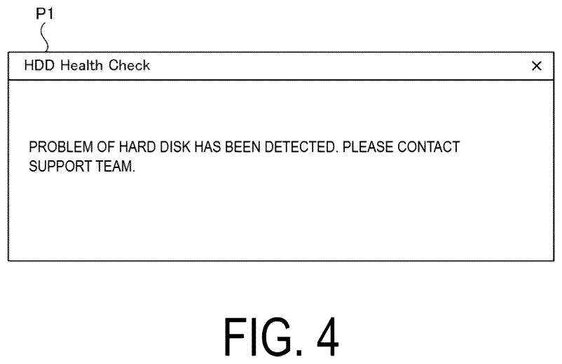

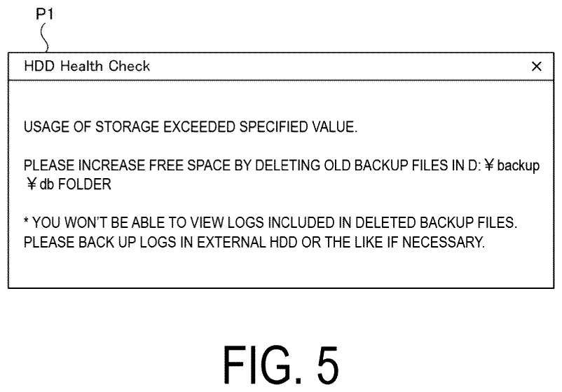

Further, when the monitoring processing unit 212 determines that an abnormality has occurred in the storage 22, the display processing unit 213 causes the operation display 23 to display abnormality information regarding the abnormality. FIGS. 4 and 5 each illustrate a message P1, which is an example of the abnormality information. FIG. 4 illustrates an example of a message displayed when an abnormality occurs in the HDD. FIG. 5 illustrates an example of a message displayed when the usage of the HDD exceeds the specified value. The message P1 includes information such as the content of the abnormality, causes of the abnormality, and countermeasures for the abnormality.

For example, the display processing unit 213 causes the message P1 to be displayed as a pop-up on a display screen of the operation display 23. When the administrator checks the mail M1 (see FIG. 3) received by the administrator terminal 3, the administrator moves to the installation location of the device to be monitored 2 and checks the message P1. In this manner, the administrator can understand the content of the abnormality and can deal with the abnormality based on the content of the message P1.

### Administrator Terminal 3

As illustrated in FIG. 2, the administrator terminal 3 includes a controller 31, a storage 32, an operation display 33, a communication unit 34, and the like. The administrator terminal 3 is an operation terminal such as a personal computer or a smartphone.

The communication unit 34 is a communication interface for connecting the administrator terminal 3 to the network N1 in a wired or wireless manner and performing data communication with another device (for example, the cloud server 1) via the network N1 in accordance with a predetermined communication protocol.

The operation display 33 is a user interface including a display such as a liquid crystal display or an organic EL display that displays various types of information and an operation unit such as a mouse, a keyboard, or a touch panel that receives an operation. The operation display 33 receives, for example, an operation of a user of the administrator terminal 3. Further, the operation display 33 displays the mail M1 (see FIG. 3) received from the cloud server 1, and the like.

The storage 32 is a non-volatile storage such as an HDD, an SSD, or a flash memory that stores various types of information. The storage 32 stores a control program that causes the controller 31 to execute various types of control processing. For example, the control program is non-temporarily recorded in a computer-readable recording medium such as a CD or a DVD, read by a reading device (not illustrated) such as a CD drive or a DVD drive included in the administrator terminal 3, and stored in the storage 32. The control program may be distributed from the cloud server 1 and stored in the storage 32.

The controller 31 includes control devices such as a CPU, a ROM, and a RAM. The CPU is a processor that executes various types of arithmetic processing. The ROM stores in advance control programs such as a BIOS and an OS for causing the CPU to execute various types of processing. The RAM stores various types of information and is used as a temporary storage memory (work area) for the various types of processing executed by the CPU. Then, the controller 31 controls the administrator terminal 3 by causing the CPU to execute various types of the control programs stored in advance in the ROM or the storage 32.

Specifically, the controller 31 causes the operation display 33 to display various types of information, and receives various types of user operations.

For example, the controller 31 receives the notification information (for example, the mail M1) from the cloud server 1, and causes the operation display 33 to display the received notification information.

As another embodiment, the controller 31 may access a website (monitoring service site) provided by the cloud server 1 in response to an operation of the administrator to register a transmission destination of the notification information, may register a device to be monitored, or may request a status of the communication path established with the device to be monitored 2.

### Monitoring Processing

Hereinafter, an example of a procedure of monitoring processing executed in the monitoring system 10 will be described with reference to FIGS. 6 and 7.

Note that the disclosure can be regarded as the disclosure of a monitoring method (an example of a monitoring method of the disclosure) that executes one or a plurality of steps included in the monitoring processing. Further, one or a plurality of the steps included in the monitoring processing described herein may be omitted as appropriate. Further, each of the steps in the monitoring processing may be executed in a different order within a range in which the same effect is obtained. Furthermore, here, a case in which the controller 11 of the cloud server 1 and the controller 21 of the device to be monitored 2 execute each of the steps in the monitoring processing will be described as an example, but in another embodiment, one or a plurality of processors may execute each of the steps in the monitoring processing in a distributed manner.

FIG. 6 illustrates an example of a procedure of monitoring processing executed by the controller 21 of the device to be monitored 2.

At step S11, the controller 21 requests the cloud server 1 to establish a communication path (for example, a WebSocket communication path). The controller 11 of the cloud server 1 establishes the communication path in response to the request for establishing the communication path (steps S21 to S22 illustrated in FIG. 7).

Upon receiving a response to the request from the cloud server 1 (S12: Yes), the controller 21 establishes the communication path at step S13.

When the communication path is established between the device to be monitored 2 and the cloud server 1, at step S14, the controller 21 monitors a component of the device to be monitored 2 and determines whether or not there is an abnormality. For example, in a case in which an abnormality of the storage 22 is detected (for example, a case in which the HDD fails, a case in which the usage of the HDD exceeds the specified value, or the like) (S14: Yes), the controller 21 transitions the processing to step S15. When the abnormality of the component is not detected (S14: No), the controller 21 transitions the processing to step S17.

At step S15, the controller 21 blocks the communication path established between the device to be monitored 2 and the cloud server 1. That is, the controller 21 sets the device to be monitored 2 and the cloud server 1 to a communication disabled state (non-connected state).

Subsequently, at step S16, the controller 21 causes the operation display 23 to display abnormality information regarding the abnormality of the component. For example, the controller 21 causes the message P1 (see FIGS. 4 and 5), which is the abnormality information, to be displayed as a pop-up on the display screen of the operation display 23. As another embodiment, when the administrator terminal 3 is data-communicably connected to the device to be monitored 2, the controller 21 may transmit the message P1 to the administrator terminal 3 by email.

Subsequently, at step S17, the controller 21 determines whether or not to end an operating state of the device to be monitored 2. When the operation state of the device to be monitored 2 ends (S17: Yes), the controller 21 ends the monitoring processing. When the operation state of the device to be monitored 2 continues (S17: No), the controller 21 transitions the processing to step S14 and repeatedly executes the above-described processing. For example, the controller 21 switches ON/OFF of the operation state based on a preset schedule.

FIG. 7 illustrates an example of a procedure of monitoring processing executed by the controller 11 of the cloud server.

At step S21, the controller 11 determines whether or not a request to establish a communication path (for example, a WebSocket communication path) has been received from the device to be monitored 2. Upon receiving the establishment request (S21: Yes), the controller 11 transitions the processing to step S22.

At step S22, the controller 11 establishes the communication path. Specifically, the controller 11 establishes the communication path when a token corresponding to the establishment request matches an issued token. When the communication path is established with the device to be monitored 2, the controller 11 registers the device information (the product name, the name, the IP address, the service information (search) IP address, the MAC address, the S/N, the installation location, the connection status, and the like) related to the device to be monitored 2. When the communication path is established, the controller 11 transmits a response to the device to be monitored 2. When the communication path is established between the device to be monitored 2 and the cloud server 1, the controller 11 starts monitoring the communication path.

At step S23, the controller 11 determines whether or not the communication path has been blocked. Upon determining that the communication path has been blocked (S23: Yes), the controller 11 transitions the processing to step S24. On the other hand, when the controller 11 determines that the communication path is not blocked (the established state is continued) (S23: No), the controller 11 transitions the processing to step S231.

At step S24, the controller 11 determines whether or not the predetermined time period has elapsed since the communication path was blocked. For example, the controller 11 determines whether or not the elapsed time from the timing at which the communication path has transitioned from the established state to the blocked state (the elapsed time in the blocked state) has reached the predetermined time period (for example, 60 minutes). When the controller 11 determines that the predetermined time period has elapsed since the communication path was blocked (S24: Yes), the controller 11 transitions the processing to step S25. When the controller 11 determines that the predetermined time period has not elapsed since the communication path was blocked (S24: No), the controller 11 transitions the processing to step S23. When the communication path is re-established (restored) before the predetermined time period elapses after the communication path was blocked (S23: No), the controller 11 transitions the processing to step S231.

At step S25, the controller 11 notifies the administrator terminal 3 of the predetermined notification information. Specifically, the controller 11 transmits, to the administrator terminal 3, the mail M1 (see FIG. 3) indicating that the communication path with the device to be monitored 2 has been blocked and that there is a possibility that an abnormality has occurred in the device to be monitored 2.

When the administrator checks the mail M1 displayed on the administrator terminal 3, the administrator goes to the installation location of the device to be monitored 2, checks the content of the abnormality (the message P1 (see FIGS. 4 and 5)) (step S16 in FIG. 6) displayed on the device to be monitored 2, and deals with the abnormality in accordance with the content of the abnormality.

Subsequently, at step S26, the controller 11 determines whether or not to end the processing (communication path monitoring processing) of monitoring the state of the communication path established with the device to be monitored 2. When it is determined to end the communication path monitoring processing (S26: Yes), the controller 11 ends the monitoring processing. On the other hand, when it is determined not to end the communication path monitoring processing (S26: No), the controller 11 transitions the processing to step S21. For example, the controller 11 determines whether or not to end the communication path monitoring processing based on a preset schedule. For example, the controller 11 ends the communication path monitoring processing on a day of the week (for example, Saturday and/or Sunday) on which the device to be monitored 2 stops operating. Further, for example, the controller 11 executes the communication path monitoring processing on a day of the week (for example, a weekday) on which the device to be monitored 2 operates. In this manner, the controller 11 may execute the monitoring processing (steps S21 to S25) based on a preset operation schedule of the device to be monitored 2.

When the communication path is not blocked and the established state is continued (S23: No), the controller 11 similarly determines whether or not to end the communication path monitoring processing at step S231. When it is determined to end the communication path monitoring processing (S231: Yes), the controller 11 ends the monitoring processing. On the other hand, when it is determined not to end the communication path monitoring processing (S231: No), the controller 11 transitions the processing to step S23.

The controller 11 of the cloud server 1 and the controller 21 of the device to be monitored 2 execute the monitoring processing, as described above.

As described above, the monitoring system 10 according to the present embodiment is a system including the device to be monitored 2 and the cloud server 1 communicably connected to the device to be monitored 2. When an abnormality of the device to be monitored 2 is detected, the device to be monitored 2 blocks the communication path established between the device to be monitored 2 and the cloud server 1. Further, when an abnormality of the device to be monitored 2 is detected, the device to be monitored 2 causes the operation display 23 of the device to be monitored 2 to display the abnormality information (see FIGS. 4 and 5) regarding the abnormality. The cloud server 1 notifies the administrator terminal 3 of the predetermined notification information (see FIG. 3) when the state in which the communication path established between the cloud server 1 and the device to be monitored 2 is blocked continues for the predetermined time period.

According to the above-described configuration, for example, in the device to be monitored 2, when the HDD fails or when the usage of the HDD exceeds the specified value, even if the communication path established between the device to be monitored 2 and the cloud server 1 is in the normal state, the device to be monitored 2 itself performs the processing of blocking the communication path. As a result, the cloud server 1 notifies the administrator terminal 3 of the notification information, using the fact that the communication path was blocked as a trigger. Furthermore, the device to be monitored 2 displays, on the operation display 23 thereof, the content of the abnormality regarding the abnormality of the HDD. As a result, after checking the notification information displayed on the administrator terminal 3, the administrator can check the content of the abnormality displayed on the device to be monitored 2. Thus, in a state in which the communication path of the device to be monitored 2 is in the normal state, when an abnormality occurs in the device to be monitored 2, it is possible to notify the administrator of the abnormality.

The monitoring system 10 according to the disclosure is not limited to the above-described embodiment. As another embodiment, in the monitoring system 10, the communication processing unit 211 of the device to be monitored 2 may block or maintain the communication path established between the device to be monitored 2 and the cloud server 1, based on the content or frequency of the abnormality of the device to be monitored 2. For example, the communication processing unit 211 may determine whether to block or maintain the communication path in accordance with the content of the abnormality. For example, when the monitoring processing unit 212 detects a failure of the storage 22 of the device to be monitored 2, the communication processing unit 211 may block the communication path, and when the monitoring processing unit 212 detects a decrease in the CPU usage rate of the device to be monitored 2, the communication processing unit 211 may maintain the communication path. Further, for example, when the number of times that the monitoring processing unit 212 detects an abnormality of a component of the device to be monitored 2 reaches a predetermined number, the communication processing unit 211 may block the communication path, and when the number of times that the abnormality is detected is less than the predetermined number, the communication processing unit 211 may maintain the communication path. According to the above-described configuration, it is possible to prevent the operation state of the device to be monitored 2 from being stopped as a result of the communication path being unnecessarily blocked.

Further, as another embodiment of the disclosure, the communication processing unit 211 of the device to be monitored 2 may block or maintain the communication path established between the device to be monitored 2 and the cloud server 1, based on an operation content in a user terminal (an example of an operation terminal of the disclosure) connected to the device to be monitored 2 in a data-communicable manner. For example, as illustrated in FIG. 8, when the device to be monitored 2 has a monitoring function of monitoring operations of a plurality of user terminals 4, the device to be monitored 2 acquires log data from each of the plurality of user terminals 4 and stores the log data. The log data includes, for example, access history information of websites accessed by the user terminals 4. In this case, the monitoring processing unit 212 detects an unauthorized access by verifying the log data. When the monitoring processing unit 212 detects the unauthorized access, the communication processing unit 211 blocks the communication path. In this manner, in the device to be monitored 2, the monitoring processing unit 212 detects an abnormality related to the operation content and the operation in the user terminal 4. That is, the monitoring processing unit 212 is configured to be able to detect an abnormality of the device to be monitored 2 itself, and also an abnormality related to the user terminal 4 monitored by the device to be monitored 2. When the communication path is blocked, the administrator checks the content of the abnormality in the device to be monitored 2 and deals with the abnormality. As a result, it is possible to prevent damage, such as the user terminal 4 being infected with a virus, due to an unauthorized access, for example.

As described above, the monitoring system 10 includes an information processing device (device to be monitored 2) to be monitored and a monitoring device (cloud server 1) communicably connected to the information processing device. When an abnormality is detected in a component of the information processing device, the information processing device blocks communication with the monitoring device and displays information regarding the abnormality, and when the monitoring device detects that the communication has been blocked for the predetermined time period or longer, the monitoring device determines that the information processing device is in an abnormal state and transmits information indicating the abnormality to the administrator terminal 3.

Further, the information processing device and the monitoring device communicate information regarding whether or not the information processing device is operating, in a bi-directional manner.

Further, the information processing device communicates with the monitoring device that is provided outside the firewall.

Further, the information processing device includes an abnormality monitoring agent (monitoring processing unit 212) that monitors the component of the information processing device, and a data communication agent (communication processing unit 211) that communicates with the monitoring device.

Further, the information processing device blocks communication based on information (log, fraudulent act, access history, virus information, or the like) regarding a set operation of another information processing device (user terminal 4) communicably connected to the information processing device.

Further, the information processing device blocks or maintains communication with the monitoring device in accordance with the content or frequency of a detected abnormality (such as a plurality of times that the abnormality has occurred).

Further, the information processing device blocks or maintains the communication based on a set specified value of the storage capacity and a degree of change in the storage capacity.

Further, the monitoring device determines that the communication has been blocked when it is detected that the communication cannot be performed continuously for a predetermined period in a period (for example, a weekday) other than a preset communication stop schedule (for example, Saturday, Sunday, or the like). For example, on Saturday and Sunday, since the device to be monitored 2 is not in operation, the determination processing of blocking or maintaining the communication is not executed.

Further, the communication path established between the information processing device and the monitoring device is a communication path that is established at all times, a communication path for life-and-death monitoring of the information processing device, a communication path for monitoring only whether or not a communication path with the information processing device is established, or the like, and is, for example, a communication path compliant with the WebSocket communication protocol.

Further, the monitoring system 10 may execute the monitoring processing using the following procedure.

(1) The data communication agent (communication processing unit 211) of the device to be monitored 2 establishes a communication path based on the WebSocket protocol, with the data communication agent (communication processing unit 111) of the cloud server 1.

(2) When the communication path is blocked, the data communication agent of the cloud server 1 notifies the administrator of the device to be monitored 2 of the notification information by email (see FIG. 3).

(3) The abnormality monitoring agent (monitoring processing unit 212) of the device to be monitored 2 monitors the state of the component of the device to be monitored 2, and upon detecting an abnormality in the component, notifies the data communication agent of the device to be monitored 2 of the abnormality.

(4) Upon receiving the notification from the abnormality monitoring agent, the data communication agent of the device to be monitored 2 blocks the communication path with the data communication agent of the cloud server 1.

(5) Upon detecting the abnormality, the abnormality monitoring agent of the device to be monitored 2 displays a pop-up window (see FIGS. 4 and 5) indicating the content of the abnormality on the monitor (operation display 23) of the device to be monitored 2.

(6) The abnormality monitoring agent of the device to be monitored 2 determines whether or not to notify the abnormality depending on the content of the detected abnormality. For example, the device to be monitored 2 may change a threshold value for notifying a capacity shortage, based on an increased amount of the drive capacity in one month.

Note that the communication path based on the WebSocket protocol may be configured not to transmit and receive data.

As another embodiment of the disclosure, the cloud server 1 may be the device to be monitored. In this case, when an abnormality occurs in the cloud server 1, the administrator can be notified of the abnormality.

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

A monitoring system according to an aspect of the disclosure includes a device to be monitored, and a monitoring device communicably connected to the device to be monitored. The device to be monitored includes a communication processing circuit that blocks a communication path established with the monitoring device when an abnormality is detected in the device to be monitored, and a display processing circuit that displays abnormality information regarding the abnormality, on a display of the device to be monitored, when the abnormality is detected in the device to be monitored. The monitoring device includes a notification processing circuit that notifies a user terminal of predetermined notification information when a state in which the communication path established with the device to be monitored is blocked continues for a predetermined time period.

### Supplementary Note 2

In the monitoring system described in Supplementary Note 1, the communication processing circuit blocks or maintains the communication path established with the monitoring device, based on a content or a frequency of the abnormality of the device to be monitored.

### Supplementary Note 3

In the monitoring system described in Supplementary Note 1 or 2, the device to be monitored further includes a monitoring processing circuit that monitors a storage of the device to be monitored. When the monitoring processing circuit detects an abnormality of the storage, the communication processing circuit blocks the communication path established with the monitoring device, and causes the display to display the abnormality information.

### Supplementary Note 4

In the monitoring system described in Supplementary Note 3, the monitoring processing circuit monitors a storage capacity of the storage, and when usage of the storage capacity exceeds a specified value, the monitoring processing circuit determines that an abnormality occurred in the storage.

### Supplementary Note 5

In the monitoring system described in any one of Supplementary Notes 1 to 4, the display processing circuit causes the display to display the abnormality information indicating that an abnormality occurred in a storage of the device to be monitored, and the notification processing circuit notifies the user terminal of the notification information indicating a possibility that the communication path established with the device to be monitored is blocked and an abnormality occurred in the device to be monitored.

### Supplementary Note 6

In the monitoring system described in any one of Supplementary Notes 1 to 5, the communication processing circuit blocks or maintains the communication path established with the monitoring device, based on an operation content in an operation terminal connected to the device to be monitored in a data-communicable manner.

### Supplementary Note 7

In the monitoring system described in any one of Supplementary Notes 1 to 6, the monitoring device monitors whether or not the communication path to be established with the device to be monitored is established.

### Supplementary Note 8

In the monitoring system described in any one of Supplementary Notes 1 to 7, the communication path is a communication path compliant with a WebSocket communication protocol.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A monitoring system comprising:
a device to be monitored; and
a monitoring device communicably connected to the device to be monitored, wherein
when an abnormality is detected in the device to be monitored, the device to be monitored blocks a communication path established with the monitoring device, and
when the abnormality is detected in the device to be monitored, the device to be monitored displays abnormality information regarding the abnormality, on a display of the device to be monitored, and
the monitoring device notifies a user terminal of predetermined notification information when a state in which the communication path established with the device to be monitored is blocked continues for a predetermined time period.

2. The monitoring system according to claim 1, wherein
the device to be monitored blocks or maintains the communication path established with the monitoring device, based on a content or a frequency of the abnormality of the device to be monitored.

3. The monitoring system according to claim 1, wherein
the device to be monitored monitors a storage of the device to be monitored, and
when an abnormality of the storage is detected, the device to be monitored blocks the communication path established with the monitoring device, and causes the display to display the abnormality information.

4. The monitoring system according to claim 3, wherein
the device to be monitored monitors a storage capacity of the storage, and
when usage of the storage capacity exceeds a specified value, the device to be monitored determines that an abnormality occurred in the storage.

5. The monitoring system according to claim 1, wherein
the device to be monitored causes the display to display the abnormality information indicating that an abnormality occurred in a storage of the device to be monitored, and
the monitoring device notifies the user terminal of the notification information indicating a possibility that the communication path established with the device to be monitored is blocked and an abnormality occurred in the device to be monitored.

6. The monitoring system according to claim 1, wherein
the device to be monitored blocks or maintains the communication path established with the monitoring device, based on an operation content in an operation terminal connected to the device to be monitored in a data-communicable manner.

7. The monitoring system according to claim 1, wherein
the monitoring device monitors whether or not the communication path to be established with the device to be monitored is established.

8. The monitoring system according to claim 1, wherein
the communication path is a communication path compliant with a WebSocket communication protocol.

9. A monitoring method comprising:
blocking a communication path between a monitoring device and a device to be monitored when an abnormality is detected in the device to be monitored;
displaying, when the abnormality is detected in the device to be monitored, abnormality information regarding the abnormality, on a display of the device to be monitored; and
notifying a user terminal of predetermined notification information when a state in which the communication path is blocked continues for a predetermined time period.

10. A non-transitory computer-readable recording medium that records a monitoring program executed in a monitoring system, wherein
the monitoring program causes one or a plurality of processors to execute
blocking a communication path between a monitoring device and a device to be monitored, when an abnormality is detected in the device to be monitored,
displaying, when the abnormality is detected in the device to be monitored, abnormality information regarding the abnormality on a display of the device to be monitored, and
notifying a user terminal of predetermined notification information, when a state in which the communication path is blocked continues for a predetermined time period.
